(19) United States
(12) Patent Application Publication
(10) Pub. No.: US 2009/0160776 A1
(43) Pub. Date: Jun. 25, 2009

(54) HAND-HELD ELECTRONIC DEVICE

(75) Inventors: Ping-Chu Tsai, Chiayi City (TW); Hung-Ming Chen, Taoyuan City (TW); Chung-Yu Liu, Taichung City (TW)

Correspondence Address: APEX JURIS, PLLC, 12733 LAKE CITY WAY NORTHEAST, SEATTLE, WA, 98125, US

(73) Assignee: MOBINNOVA HONG KONG LIMITED, Hong Kong (CN)

(21) Appl. No.: 12/036,173

(22) Filed: Feb. 22, 2008

(30) Foreign Application Priority Data
Dec. 19, 2007 (TW) 096148783

(51) Int. Cl. G06F 3/02

(52) U.S. Cl. 345/169

(57) ABSTRACT

A hand-held electronic device being held by a user with a single hand for dialing or with both hands for inputting characters includes a body, a keyboard, two sensors respectively disposed on two opposite sides of the body, and a backlight source. The keyboard has keys forming a region marked with a QWERTY keyboard and a region overlapping the above region and marked with a phone keypad. The sensors detect whether the body is held by a single hand on one side or by both hands on two sides and let the backlight source light up the region marked with the phone keypad on the keyboard when the body is held by a single hand. Thus, the region marked with the phone keypad is highlighted out of the QWERTY keyboard, so it is easy for the user to identify the key numbers and dial quickly.

### CROSS-REFERENCE TO RELATED APPLICATIONS

This non-provisional application claims priority under 35 U.S.C. §119(a) on Patent Application No(s). 096148783 filed in Taiwan, R.O.C. on Dec. 19, 2007, the entire contents of which are hereby incorporated by reference.

### BACKGROUND OF THE INVENTION

1. Field of Invention

The present invention relates to a hand-held electronic device, and more particularly to a hand-held electronic device capable of assisting a user to identify symbols on the keyboard.

2. Related Art

Mobile phone is an indispensable communication tool in the modern life, and is one type of hand-held electronic devices, mainly for carrying out mobile audio or video communication. The main body of a conventional mobile phone is provided with a display and a phone keypad. The phone keypad consists of Arabic numerals 0-9 and special keys such as *, #, ON, CUT, so as to be dialed by a user, such that the user is able to carry out any particular function of the mobile phone.

Recently, as Electronic and Mobile Commerce (EC/MC) is widely applied to various industries, many mobile phone manufacturers seize the opportunity to put forward business hand-held electronic devices especially for commercial purposes. For example, a smart phone is combined with functions of a conventional mobile phone and a personal digital assistant (PDA), such that a mobile phone is no longer limited to audio or video communication. Thus, a smart phone can not only be used for mobile communication, but is also built with an operating software similar to that in a personal computer, so as to receive/send e-mails through wireless network or to store various computer word software files for direct edition and reading.

Currently, the most popular business hand-held electronic device is definitely Blackberry manufactured by Research In Motion Ltd. (RIM). Business people can use Blackberry to fulfill various mobile business functions, such as to receive/send e-mails, surf the network, and carry out real-time communication. Thus, it is necessary for the Blackberry to be equipped with a QWERTY keyboard constituted by a plurality of keys like those on a computer keyboard and also a conventional phone keypad, which both serve as input media of preset functions of the Blackberry, and make it easy for those familiar with computer operation to get accustomed to the arrangement of the keys. To prevent an oversized keyboard taking up too much space, most of the business hand-held electronic devices have the numerical symbols of the phone keypad integrated into some English character keys on the QWERTY keyboard, and switched under the control of a built-in software, such that a user can either input numbers or English characters. However, such a keyboard with mixed English characters and numbers makes it difficult for the user to identify the positions of the number keys, and may result in an input error or inefficiency in dialing. Further, as there are plenty of keys on the QWERTY keyboard, and the numerical symbols of the phone keypad are generally arranged intensively, it is also inconvenient for the user to dial phone numbers.

### SUMMARY OF THE INVENTION

Accordingly, the present invention is directed to a hand-held electronic device, so as to solve problems concerning a QWERTY keyboard of a business hand-held electronic device in the prior art.

In order to solve the above problems, the present invention provides a hand-held electronic device capable of being held by a user with a single hand or both hands for operation. The hand-held electronic device of the present invention includes a body, a keyboard, a first sensor, a second sensor, and a first backlight source. The body has a first holding side and an opposite second holding side. The keyboard is disposed on the body and located between the first holding side and the second holding side. Further, the keyboard has a plurality of keys, and the keys form a first operating region and a second operating region containing the first operating region. The first sensor is disposed on the first holding side of the body, for sending a sensing signal when the first holding side is held by the user. The second sensor is disposed on the second holding side of the body, for sending a sensing signal when the second holding side is held by the user. The first backlight source is disposed on the body and corresponding to the first operating region. In addition, the first backlight source emits light according to the sensing signal from the first sensor or the second sensor, so as to light up the first operating region on the keyboard. However, on receiving sensing signals from the first sensor and the second sensor at the same time, the first backlight source will not emit light. In a preferred embodiment of the present invention, each key in the first operating region is marked with a symbol of a phone keypad, and each key in the second operating region is marked with a symbol of a QWERTY keyboard. As such, when the body is held by the user with a single hand for dialing phone numbers, the region marked with symbols of the phone keypad on the keyboard is lighted by the first backlight source, and when the body is held by the user with both hands for inputting characters, the region marked with symbols of the phone keypad on the keyboard will not be lighted.

The efficacy of the present invention is that, the first and second sensors detect whether the body of the device is held by the user with a single hand or both hands. As such, the first backlight source lights up the first operating region when the device is held by the user with a single hand for dialing phone numbers. Thus, the region marked with symbols of the phone keypad is highlighted out of a QWERTY keyboard, so it is easy for the user to identify the key numbers and dial quickly.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a hand-held electronic device according to a first embodiment of the present invention.

FIG. 2 is a schematic view showing the hand-held electronic device held by a user with a single hand for operation according to the first embodiment of the present invention.

FIG. 3 is a schematic view showing the hand-held electronic device held by a user with a single hand for operation according to the first embodiment of the present invention.

FIG. 4 is a schematic view showing the hand-held electronic device held by a user with both hands for operation according to the first embodiment of the present invention.

FIG. 5 is a schematic view showing a hand-held electronic device held by a user with a single hand for operation according to a second embodiment of the present invention.

FIG. 6 is a schematic view showing the hand-held electronic device held by a user with a single hand for operation according to the second embodiment of the present invention.

FIG. 7 is a schematic view showing the hand-held electronic device held by a user with both hands for operation according to the second embodiment of the present invention.

FIG. 8 is a schematic view showing a hand-held electronic device held by a user with a single hand for operation according to a third embodiment of the present invention.

FIG. 9 is a schematic view showing the hand-held electronic device held by a user with a single hand for operation according to the third embodiment of the present invention.

FIG. 10 is a schematic view showing the hand-held electronic device held by a user with both hands for operation according to the third embodiment of the present invention.

### DETAILED DESCRIPTION OF THE INVENTION

The present invention provides a hand-held electronic device, for example, a mobile phone, wireless phone, hand-held computer, PDA, or hand-held game console. However, only a business mobile phone both equipped with a phone keypad and a QWERTY keyboard is considered as the most preferred embodiment and illustrated below.

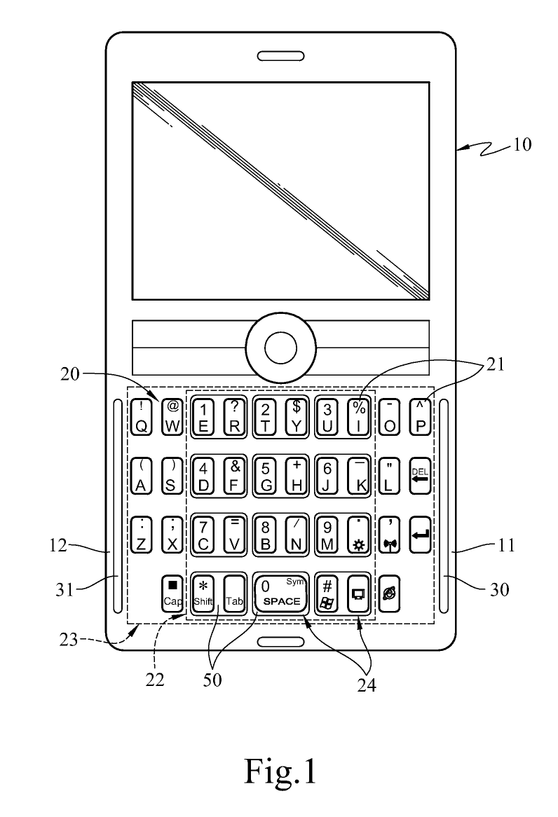

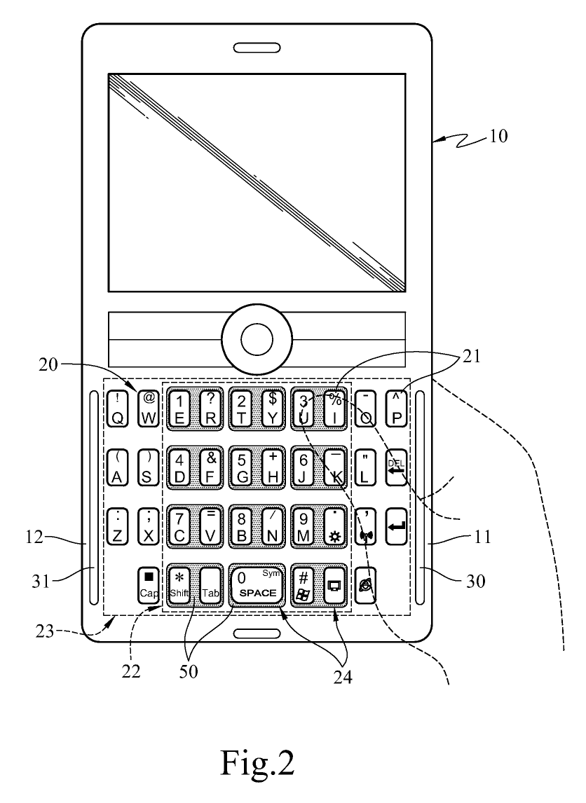

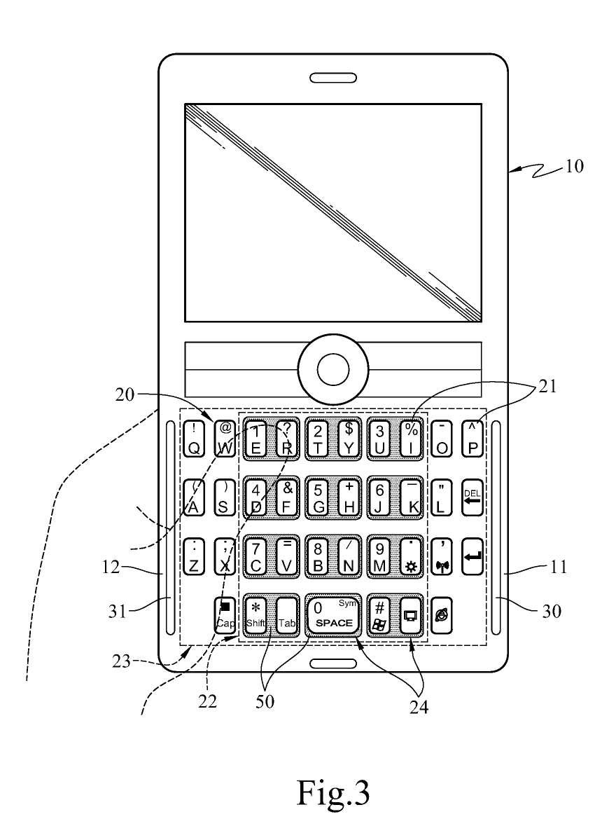

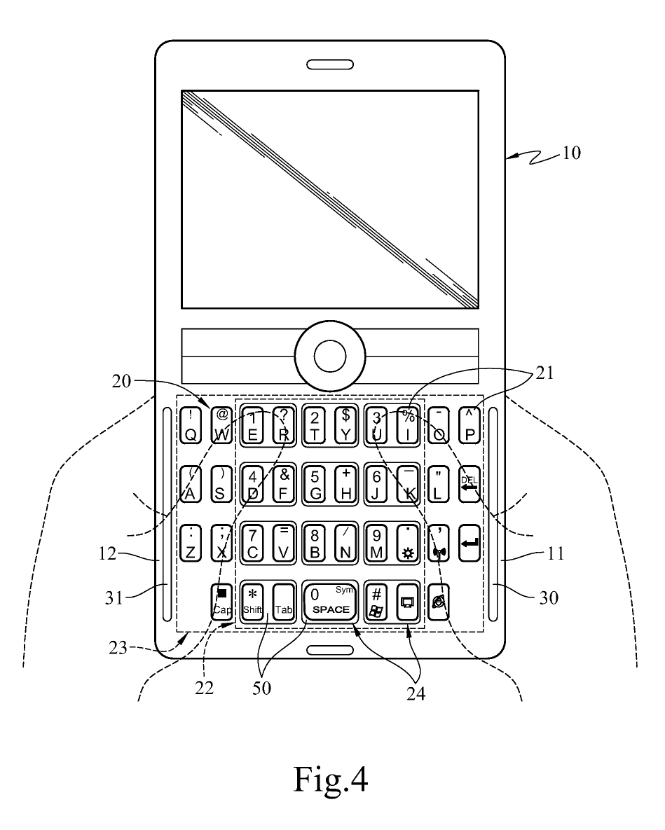

Referring to FIGS. 1-4, a hand-held electronic device according to a first embodiment of the present invention is shown, and the device is capable of being held by a user with a single hand or both hands for operation. FIGS. 2 and 3 respectively show the hand-held electronic device held by a user with a single hand for operation according to the first embodiment of the present invention. FIG. 4 shows the hand-held electronic device held by a user with both hands for operation according to the first embodiment of the present invention. The hand-held electronic device of the present invention includes a body 10, a keyboard 20, a first sensor 30, a second sensor 31, and a first backlight source 50.

Referring to FIG. 1, the body 10 has a first holding side 11 and an opposite second holding side 12. The first holding side 11 and the second holding side 12 can be held by a user with both hands (left and right hands) simultaneously, or with a single hand (left or right hand) each time.

Referring to FIG. 1, the keyboard 20 is disposed on the body 10, and located between the first holding side 11 and the second holding side 12. The keyboard 20 has a plurality of keys 21, and the keys 21 form a first operating region 22 and a second operating region 23 containing the first operating region 22. The first operating region 22 is constituted by a plurality of keys 21 located at the center of the keyboard 20, and the second operating region 23 is constituted by all the keys 21 on the keyboard 20. Each key 21 in the first operating region 22 is marked with a symbol of a phone keypad, such as an Arabic numeral of 0-9 or a special key like *, #. Each key 21 in the second operating region 23 is marked with a symbol of a QWERTY keyboard, for example, English characters A to Z, punctuations, and functional symbols. Actually, the first operating region 22, overlapped by the second operating region 23, contains a part of the symbols of a QWERTY keyboard and all the symbols of a phone keypad, and is able to switch between an operating mode of a phone keypad and that of a QWERTY keyboard under the control a built-in software.

Referring to FIG. 1, the first operating region 22 is constituted by a plurality of sub-regions 24, and each sub-region 24 has one key 21 or two keys 21. For example, the key 21 marked with E and 1 is in the same sub-region 24 as the key 21 marked with R and ?, while the key 21 marked with 0 and SPACE is in one sub-region 24 independently. When the keyboard 20 is in an operating mode of the phone keypad, the keys 21 within the same sub-region 24 represent one number. For example, the number 1 is obtained by either pressing the key 21 marked with E and 1 or the key 21 marked with R and ?. As such, the operating area of the phone keypad is increased among the intensively arranged keys 21, and it is easier for the user to operate.

Referring to FIGS. 1-4, the first sensor 30 is disposed on the first holding side 11 of the body 10, for sending a sensing signal when the first holding side 11 is held by the user. The second sensor 31 is disposed on the second holding side 12 of the body 10, for sending a sensing signal when the second holding side 12 is held by the user. The first sensor 30 or the second sensor 31 may detect whether the user holds the first holding side 11 or the second holding side 12 through photo-sensing, i.e., the first sensor 30 or the second sensor 31 sends the sensing signal when blocked by a hand of the user. The first sensor 30 or the second sensor 31 may detect whether the user holds the first holding side 11 or the second holding side 12 through contact sensing, i.e., the first sensor 30 or the second sensor 31 sends the sensing signal when being in contact with a hand of the user. In this embodiment, the first sensor 30 and the second sensor 31 are located outside the second operating region 23 of the keyboard 20.

Referring to FIGS. 1-4, the first backlight source 50 is disposed on the body 10, and corresponding to the first operating region 22 of the keyboard 20. The first backlight source 50 is, but not limited to, a light-emitting diode (LED). The first backlight source 50 is electrically connected to the first sensor 30 and the second sensor 31, for receiving sensing signals sent from the two, and emits light according to the sensing signal from the first sensor 30 or the second sensor 31, so as to light up the first operating region 22 of the keyboard 20. In this embodiment, the first backlight source 50 respectively lights up the sub-regions 24 of the first operating region 22. As such, on receiving the sensing signal from the first sensor 30 or the second sensor 31, the first backlight source 50 emits light to light up the first operating region 22. However, on receiving the sensing signals from the first sensor 30 and the second sensor 31 at the same time, the first backlight source 50 will not emit light.

Referring to FIGS. 2 and 3, when the body 10 is held by the user with a single hand, the first sensor 30 on the first holding side 11 or the second sensor 31 on the second holding side 12 detects the hand of the user and then sends the sensing signal. Generally speaking, the user holds the device with a single hand for dialing phone numbers, and then keeps holding the device with a single hand to make a call. In this circumstance, the first backlight source 50 receives the sensing signal from the first sensor 30 or the second sensor 31, and emits light to light up the sub-regions 24 in the first operating region 22, such that the region marked with symbols of a phone keypad on the keyboard 20 will be lighted. In another aspect, the keys 21 of the first operating region 22 are switched to an operating mode of a phone keypad through the software built-in the hand-held electronic device, so as to enable the user to dial phone numbers.

Referring to FIG. 4, when the body 10 is held by the user with both hands, the first sensor 30 on the first holding side 11 and the second sensor 31 on the second holding side 12 both detect a hand of the user and then respectively send a sensing signal. Generally, the user holds the device with both hands for inputting characters, for example, editing short-messages or files. In this circumstance, the first backlight source 50 receives the sensing signals from both the first sensor 30 and the second sensor 31, and will not emit light, such that the region marked with symbols of a phone keypad on the keyboard 20 will not be lighted. In another aspect, the keys 21 of the second operating region 23 are switched to an operating mode of a QWERTY keyboard through the software built-in the hand-held electronic device, so as to enable the user to input characters.

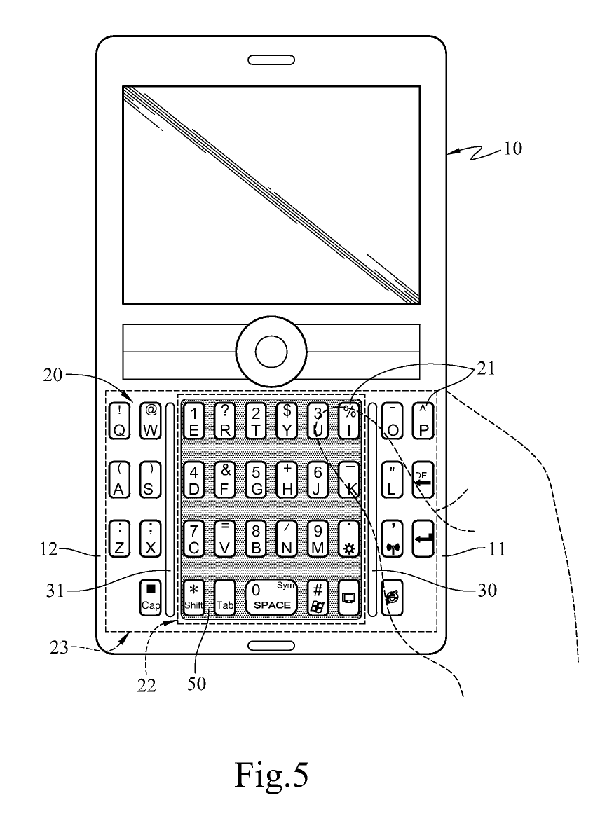

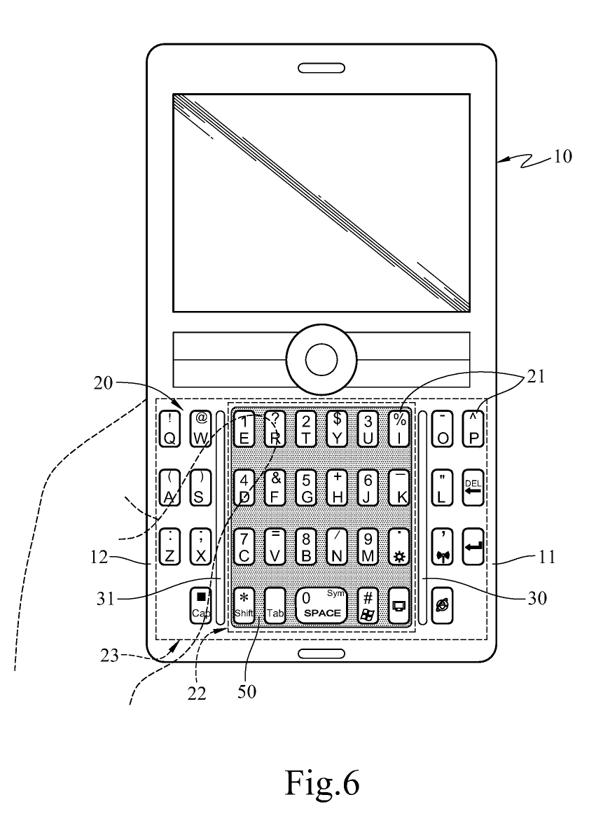

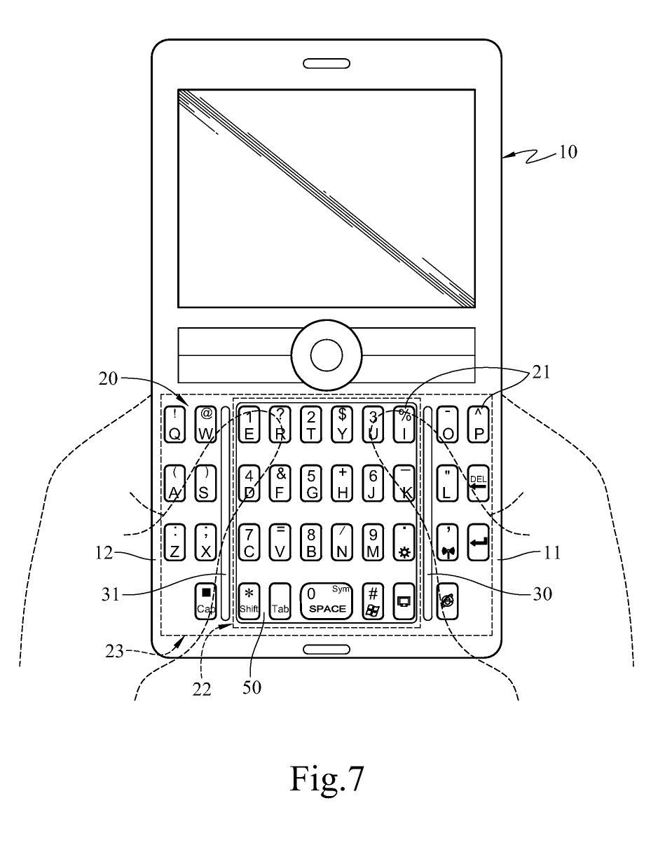

Referring to FIGS. 5, 6, and 7, a hand-held electronic device according to a second embodiment of the present invention is shown. FIGS. 5 and 6 respectively show the hand-held electronic device held by a user with a single hand for operation according to the second embodiment of the present invention. FIG. 7 shows the hand-held electronic device held by a user with both hands for operation according to the second embodiment of the present invention. The second embodiment is similar to the first embodiment, and the only difference is that the first backlight source 50 of the second embodiment emits light to directly light up the whole first operating region 22, and the first sensor 30 and the second sensor 31 are located in the second operating region 23. As such, the first sensor 30 and the second sensor 31 are located close to the center of the keyboard 20, i.e., at the two sides of the first operating region 22, so as to prevent the first sensor 30 and the second sensor 31 from sending sensing signals at the same time when the first holding side 11 and the second holding side 12 of the body 10 are held by the user with a single hand, thus avoiding considering in mistake that the device is held by both hands. Of course, other preventing mechanisms may also be adopted. For example, the first sensor 30 and the second sensor 31 are staggered, or employ different sensing manners, and these mechanisms all fall within the scope of the present invention.

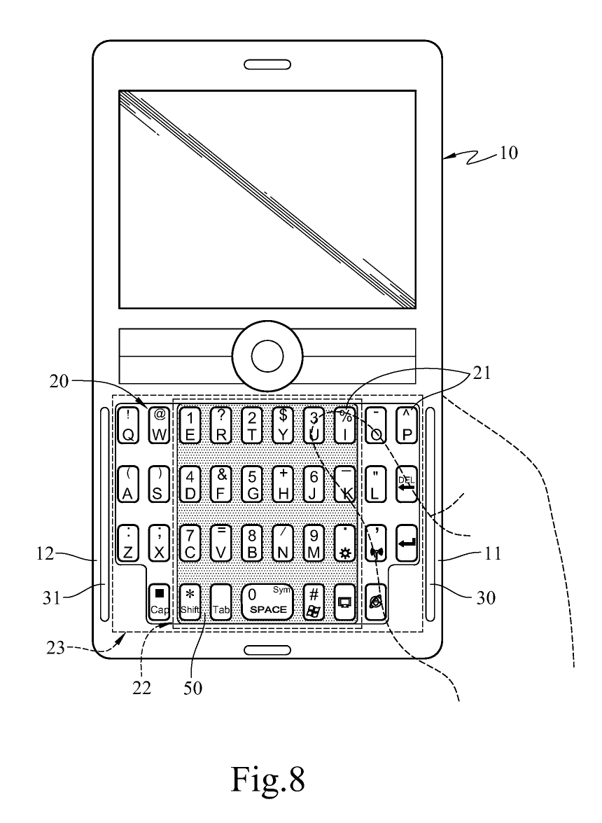

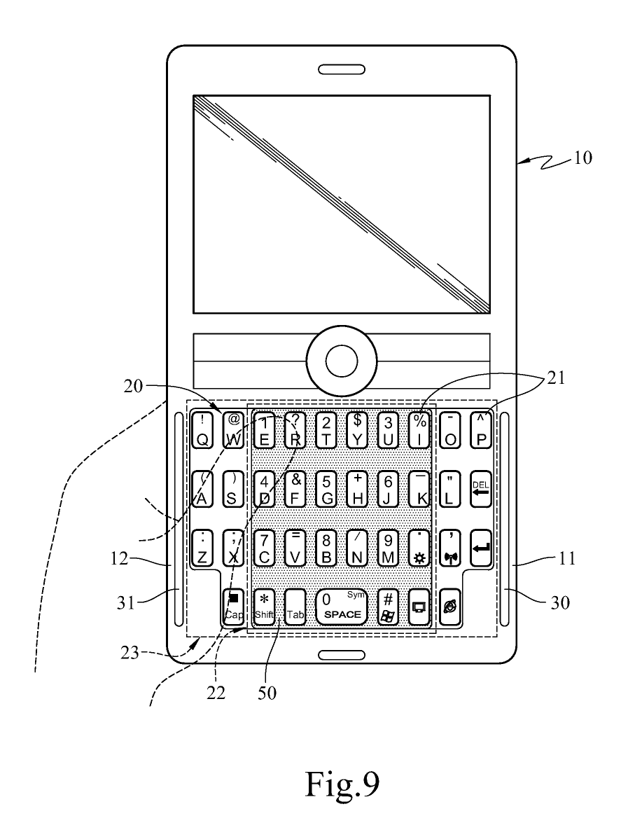

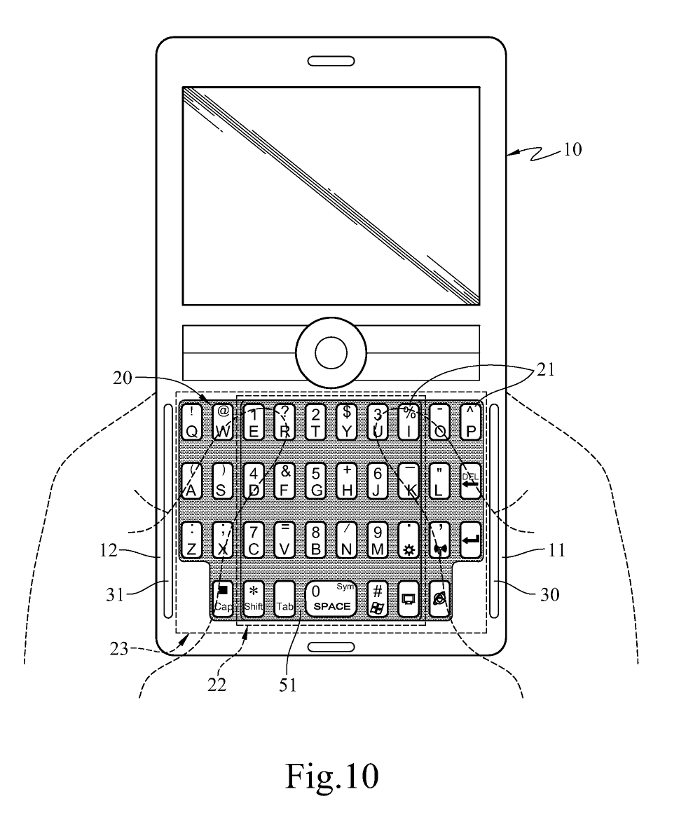

Referring to FIGS. 8, 9, and 10, a hand-held electronic device according to a third embodiment of the present invention is shown. FIGS. 8 and 9 respectively show the hand-held electronic device held by a user with a single hand for operation according to the third embodiment of the present invention. FIG. 10 shows the hand-held electronic device held by a user with both hands for operation according to the third embodiment of the present invention. The hand-held electronic device of this embodiment includes a body 10, a keyboard 20, a first sensor 30, a second sensor 31, a first backlight source 50, and a second backlight source 51. The second backlight source 51 is, but not limited to, an LED, and the color of the light emitted by the second backlight source 51 may be identical to or different from that of the first backlight source 50. For example, the light emitted by the second backlight source 51 and the first backlight source 50 is both blue, or the light from the second backlight source 51 is blue and that from the first backlight source 50 is of a different color. The first backlight source 50 emits light according to a sensing signal of the first sensor 30 or the second sensor 31, so as to light up the whole first operating region 22 of the keyboard 20. The second backlight source 51 emits light according to the sensing signals of both the first sensor 30 and the second sensor 31, so as to light up the whole second operating region 23. Therefore, when the user holds the body 10 with a single hand for dialing phone numbers, the first backlight source 50 lights up the region marked with symbols of a phone keypad on the keyboard 20, and when the user holds the body 10 with both hands for inputting characters, the second backlight source 51 lights up the region marked with symbols of a QWERTY keyboard on the keyboard 20.

In the present invention, the first sensor 30 and the second sensor 31 detect whether the body 10 is held by a user with a single hand or both hands, and the first backlight source 50 lights up the first operating region 22 when the user holds the device with a single hand for dialing phone numbers. As such, the region marked with symbols of a phone keypad is highlighted out of a QWERTY keyboard, so it is easy for the user to identify the key numbers and dial quickly.

What is claimed is:

1. A hand-held electronic device, capable of being held by a user with a single hand or both hands, comprising:
a body, having a first holding side and an opposite second holding side;
a keyboard, disposed on the body and located between the first holding side and the second holding side, wherein the keyboard has a plurality of keys, and the keys form a first operating region and a second operating region containing the first operating region;
a first sensor, disposed on the first holding side;
a second sensor, disposed on the second holding side; and
a first backlight source, disposed on the body and corresponding to the first operating region, wherein the first backlight source emits light according to a sensing signal from the first sensor or the second sensor, so as to light up the first operating region.

2. The hand-held electronic device as claimed in claim 1, wherein the first operating region is constituted by the keys located at the center of the keyboard.

3. The hand-held electronic device as claimed in claim 1, wherein the second operating region is constituted by all the keys on the keyboard.

4. The hand-held electronic device as claimed in claim 1, wherein each key in the first operating region is marked with a symbol of a phone keypad.

5. The hand-held electronic device as claimed in claim 1, wherein each key in the second operating region is marked with a symbol of a QWERTY keyboard.

6. The hand-held electronic device as claimed in claim 1, wherein the first sensor and the second sensor are located in the second operating region.

7. The hand-held electronic device as claimed in claim 1, wherein the first sensor and the second sensor are located out of the second operating region.

8. The hand-held electronic device as claimed in claim 1, wherein the first operating region is constituted by a plurality of sub-regions, each sub-region has at least one key, and the first backlight source lights up the sub-regions.

9. A hand-held electronic device, capable of being held by a user with a single hand or both hands, comprising:
a body, having a first holding side and an opposite second holding side;
a keyboard, disposed on the body and located between the first holding side and the second holding side, wherein the keyboard has a plurality of keys, and the keys form a first operating region and a second operating region containing the first operating region;
a first sensor, disposed on the first holding side;
a second sensor, disposed on the second holding side;
a first backlight source, disposed on the body and corresponding to the first operating region; and
a second backlight source, disposed on the body and corresponding to the second operating region;
wherein the first backlight source emits light according to a sensing signal from the first sensor or the second sensor, so as to light up the first operating region, and the second backlight source emits light according to sensing signals of both the first sensor and the second sensor, so as to light up the second operating region.

10. The hand-held electronic device as claimed in claim 9, wherein the first operating region is constituted by the keys located at the center of the keyboard.

11. The hand-held electronic device as claimed in claim 9, wherein the second operating region is constituted by all the keys on the keyboard.

12. The hand-held electronic device as claimed in claim 9, wherein each key in the first operating region is marked with a symbol of a phone keypad.

13. The hand-held electronic device as claimed in claim 9, wherein each key in the second operating region is marked with a symbol of a QWERTY keyboard.

14. The hand-held electronic device as claimed in claim 9, wherein the first sensor and the second sensor are located in the second operating region.

15. The hand-held electronic device as claimed in claim 9, wherein the first sensor and the second sensor are located out of the second operating region.

16. The hand-held electronic device as claimed in claim 9, wherein the first operating region is constituted by a plurality of sub-regions, each sub-region has at least one key, and the first backlight source lights up the sub-regions.
